(19) United States
(12) Patent Application Publication
(10) Pub. No.: US 2008/0021788 A1
(43) Pub. Date: Jan. 24, 2008

(54) Internet access device to facilitate financial services at a fuel dispenser

(75) Inventors: David Dodson, Virginia Beach, VA (US); Ervin Smith, Monroe, IN (US)

Correspondence Address: BAKER & DANIELS LLP;111 E. WAYNE STREET, SUITE 800, FORT WAYNE, IN, 46802, US

(73) Assignee: TOKHEIM HOLDINGS, B.V., Ad Bladel (NL)

(21) Appl. No.: 11/893,135

(22) Filed: Aug. 14, 2007

Related U.S. Application Data
(63) Continuation of application No. 10/234,499, filed on Dec. 2, 2002, now abandoned.
(60) Provisional application No. 60/317,815, filed on Sep. 5, 2001.

(51) Int. Cl. G06Q 30/00; G06F 17/30; G06F 3/01

(52) U.S. Cl. 705/17; 709/217

(57) ABSTRACT

An Internet-enabled fuel dispenser includes a card reader adapted to retrieve a Uniform Resource Locator (URL) data element from a portable card encoded with the URL information and carried by the customer. A client machine at the dispenser position accesses the World Wide Web server specified by the retrieved URL data element and receives a Web page downloaded from the accessed server. The Web page includes customer financial information representing various payment options such as digital cash and credit card account numbers. The Web page is presented for viewing on a graphical user interface (GUI) touch-screen display that enables the customer to select one of the displayed payment options and thereby initiate further processing of the refueling transaction request by submitting the payment selection to the refueling point-of-sale (POS) facility.

This application hereby claims the benefit under Title 35, United States Code §119(e) of U.S. application No. 60/317,815 filed on Sep. 5, 2001.

### BACKGROUND OF THE INVENTION

1. Field of the Invention

The present invention relates to a method and apparatus for providing payment for a refueling transaction in a fuel dispenser environment, and, more particularly, to a system utilizing a card encoded with a Uniform Resource Locator (URL) for accessing a specified Internet Web page listing various methods of payment and downloading the Web page to the fuel dispenser position to enable the customer to select one of the displayed payment options.

2. Description of the Related Art

Refueling service station operators have deployed various mechanisms to interface with the customer and enable a payment option to be selected. Among these mechanisms, the most widely utilized are magnetic card readers, RFID tags, and bar-coded cards for initiating a credit transaction. For each of these devices, a unique financial account number is carried by the device, such as an electronic signal embedded in a magnetic or RFID card and a visual signal imprinted on a bar-coded card.

This account number is used by the POS system to initiate a credit transaction with a dedicated credit transaction network. This embedded number is also used by the POS system for local promotions and discounts. The number of such credit card, promotional cards, and RFID tags has increased significantly over the years as petroleum operators providing ancillary convenience store services attempt to increase brand loyalty with a proprietary payment method.

However, this emergence of commercial activity has imposed upon the participating customer the need to carry around multiple physical credit cards, RFID tags, bar-coded cards, and other such devices to take advantage of the various services provided by multiple merchants. Examples of these services include low credit card interest rates, promotional specials, airline and other frequent buyer points, as well as payment services that separate personal expenses from business, expenses.

The number of different cards and similar devices increases the likelihood that theses devices will be lost or misplaced, opening the possibility of fraudulent use. Additionally, it is inconvenient to carry around a large number of cards and devices simply to initiate a financial transaction at a gasoline dispenser.

### SUMMARY OF THE INVENTION

According to the present invention there is provided a method and apparatus for enabling a customer requesting a refueling transaction in a fuel dispenser environment to access the Internet at the fuel dispenser position and retrieve a Web page displaying various types of payment options. In a preferred form, a data storage device provided in the form of a portable card-type mechanism is encoded with a Uniform Resource Locator (URL) data element that specifies the Internet location of the desired document, i.e., the server name and path name to the file. The retrieved Web page is downloaded to the requester client machine (e.g., the computing device at the Internet-enabled dispenser position) and then presented for viewing on a suitable multi-media display.

Preferably, the display and Web page presentation are adapted to enable the customer to select one of the displayed payment options, such as a credit card account. For example, the display may include a touch-screen that allows the customer to select a payment option, which may be represented on the screen in the form of a graphic icon or menu item. The selected payment option is then forwarded to the point-of-sale (POS) facility associated with the refueling environment for conventional processing, such as executing an authorization check of the specified account to verify that sufficient funds are available.

The invention, in one form thereof, is directed to a system for use in a fuel dispenser environment. The system includes, in combination, a connection facility enabling connection to a communications network; a data means for providing at least one resource identifier each specifying a host resource in the communications network; and an access means, operatively coupled to the connection facility, for accessing the host resource specified by a one of the at least one resource identifier and for receiving information retrieved therefrom.

The resource identifier further includes at least one Uniform Resource Locator (URL) data element. The communications network further includes the Internet (and particularly the World Wide Web), while the host resource associated with each resource identifier further includes at least one server having a Web page document containing customer transaction information relating to payment options. In particular, the transaction information further includes at least one selectable payment option each representing a form of payment.

A user-interface display is provided to present the downloaded transaction information and to enable a selection operation relative to the at least one selectable payment option. A point-of-sale facility operatively conducts a refueling transaction operation using the payment option selection.

The data means, in one form thereof, includes a device containing at least one Uniform Resource Locator (URL) data element, and a retrieval mechanism to retrieve the at least one URL data element from the device. In a preferred form, the URL device is implemented as a card-type element furnished by a customer, such as a URL-encoded magnetic card capable of being read by a magnetic card reader.

The invention, in another form thereof, is directed to a system for use in a fuel dispenser environment having a plurality of dispenser positions. The system includes a connection means for enabling connection to a communications network. Each dispenser position respectively comprises, in combination, a mechanism to provide at least one resource identifier each specifying a host resource in the communications network, and an access device to access the host resource specified by a one of the at least one resource identifier and to receive information retrieved therefrom.

The at least one resource identifier further includes at least one Uniform Resource Locator (URL) data element. In a preferred form, the communications network further includes the Internet, while the host resource associated with each resource identifier further includes at least one server. Additionally, information retrieved from an accessed host resource further includes a World Wide Web page document containing customer information relating to payment options.

The mechanism to provide the host resource identifier preferably includes, in combination, a device containing at least one Uniform Resource Locator (URL) data element, and a retrieval mechanism to retrieve the at least one URL data element from the device.

The Web page information downloaded from the host resource preferably includes at least one selectable payment option each representing a form of payment. The system further includes a means to present the downloaded information and to enable a selection operation relative to the at least one selectable payment option.

The invention, in another form thereof, is directed to an apparatus for use in combination with a fuel dispenser environment and a communications network. The apparatus includes, in combination, a connection device to connect to the communications network; a mechanism to provide at least one Uniform Resource Locator (URL) data element each specifying a host resource in the communications network; and an access device to access the host resource specified by a one of the at least one resource identifier and to receive information retrieved therefrom.

The mechanism to provide the URL data element further comprises, in combination, a portable storage device containing the at least one URL data element, and a retrieval device to retrieve the at least one URL data element from the portable storage device. In a preferred form, the storage device is implemented in the form of a URL-encoded card, and the retrieval device includes a read module adapted to enable operative reading of the card.

The information received by the access device further includes at least one selectable payment item each representing a form of payment for use in facilitating a refueling transaction. The apparatus includes a display to enable presentation of the information received by the access device. The display, in a preferred form, is adapted to enable user selection of selectable items presented by the display. More specifically, the display may include a touch-screen facility.

Preferably, information retrieved from an accessed host resource further includes a World Wide Web page document containing customer information relating to payment options.

The invention, in yet another form thereof, is directed to a method for use in a fuel dispenser environment having a connection to a communications network. The method involves, in combination, providing at least one resource identifier each specifying a host resource in the communications network; accessing the host resource specified by a one of the at least one resource identifier; and retrieving information from the accessed host resource.

In a preferred form, the at least one resource identifier further includes at least one Uniform Resource Locator (URL) data element. Additionally, the communications network further includes the Internet, and the host resource associated with each resource identifier further includes at least one server.

According to one form of the method, the step of providing at least one resource identifier further comprises the steps of providing a card-type device containing at least one Uniform Resource Locator (URL) data element, and retrieving the at least one URL data element from the card-type device.

Moreover, information retrieved from an accessed host resource further includes a World Wide Web page document containing customer information relating to payment options. In particular, such downloaded information includes customer transaction information having at least one selectable payment item each representing a form of payment. The method further includes processing the customer transaction information to enable selection of a one of the at least one selectable payment item.

One advantage of the present invention is that the refueling customer need only carry a single card-type mechanism encoded with the URL of the customized financial Web page in order to acquire access to a variety of payment options, as compared to the conventional requirement that each payment method have a dedicated card encoded with the respective account information that the customer must carry at all times.

Another advantage of the present invention is that the available set of payment options may be modified by simply updating the financial Web page with the new or revised account information.

A further advantage of the invention is that the apparatus for accessing the Internet and downloading the requested Web page operates seamlessly with the conventional POS facility and other transaction processing modules.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram illustration of an Internet-enabled fuel dispenser position, according to one embodiment of the present invention; and

FIG. 2 is a block diagram illustration of an Internet-enabled fuel dispenser position, according to another embodiment of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

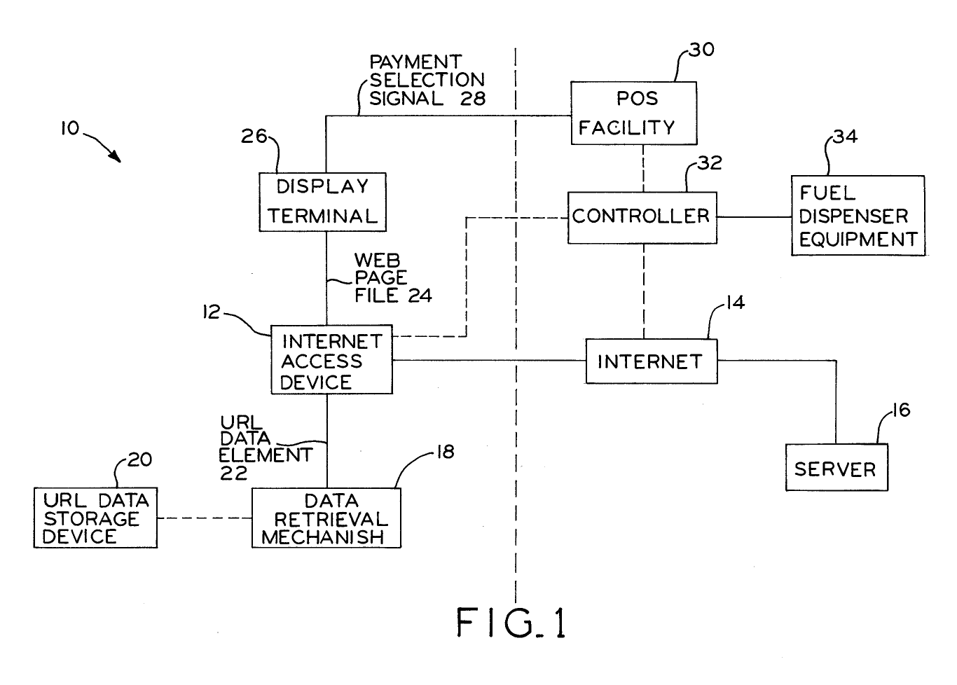

Referring now to the drawings and particularly to FIG. 1, there is shown in illustrative block diagram format an Internet-enabled fuel dispenser position 10 located at a refueling environment such as a service station facility, according to one embodiment of the present invention. Although only a single dispenser position 10 is shown for purposes of clarity, it should be apparent that the refueling environment may include a plurality of such dispenser positions 10 each dedicated to serving a particular customer.

The illustrated dispenser position 10 includes an Internet access device 12 enabling communications with Internet 14 having an interconnected network of servers 16. Internet 14 preferably includes the World Wide Web (WWW). Although Internet 14 constitutes the preferred communications facility, it should be apparent that dispenser position 10 may be suitably enabled for connection to any communications network. Accordingly, Internet access device 12 may be provided in any form suitable for establishing a networked connection to the specified communications network.

The illustrated Internet access device 12 functions in a known manner to provide access to the files and any other information stored by server 16 or provided by any other host resource in Internet 14. In one form, access device 12 may be configured as a client machine or requester device to provide the well known client-server relationship effectuated by the Internet. Access device 12 may include, but is not limited to, a personal computer having a suitable connection device for connecting to Internet 14. For example, a connection to Internet 14 may be established over a conventional telephone line, a cable line, or a wireless link, thereby requiring a suitable modem or RF transceiver.

The illustrated dispenser position 10 further includes a data retrieval mechanism 18 for use in combination with a URL data storage device 20. The illustrated storage device 20 encompasses any mechanism capable of containing or otherwise bearing identification data sufficient to specify the location or address of a host resource in Internet 14. Information associated with storage device 20 is preferably machine readable.

In a preferred form, this host resource identification data is provided in the form of a conventionally constructed Uniform Resource Locator (URL) data element encoded or otherwise carried by storage device 20. For example, the URL data element may correspond to a character string such as the URL http://www.CustomerWebPage.com/index/uniquefinancial.asp to specify the transfer format or type of access method being used (HyperText Transfer Protocol), the server location which hosts the Web site or more generally the host name of the machine that holds the requested file (www.CustomerWebPage.com), and the path name to the file (index/uniquefinancial.asp).

The illustrated data retrieval mechanism 18 is configured to interact cooperatively with data storage device 20 to retrieve the URL data element 22 therefrom. The URL data storage device 20 may be provided in various alternative forms including, but not limited to, a magnetic card, a bar code device, a smart card, or wireless communications device, such as an RFID tag affixed to a vehicle. For this purpose, data retrieval mechanism 18 will be suitably implemented in the form of a magnetic card reader, a bar code reader, a smart card reader, and a wireless receiver (such as an RF transceiver). It should be apparent that data retrieval mechanism 18 will be implemented in a form tailored to the manner in which the URL data element is stored.

The URL data element 22 obtained by retrieval mechanism 18 from URL data storage device 20 is forwarded to Internet access device 12 for use in navigating Internet 14 and accessing a host resource based upon the server location address specified by URL data element 22. As well known to those skilled in the art, this access procedure generally involves Internet access device 12 formulating a request to server 16 (as specified by the URL) and then server 16 processing the request to download the requested file or document as a Web page, for example.

Internet access device 12 is configured in a manner well known to those skilled in the art to incorporate a facility that suitably processes the URL data element 22, formulates a document request in accordance with the URL, and transmits the request to Internet 14. For example, access device 12 may be equipped with a suitable browser program that automatically enters the URL information into the Internet location address field and then activates the Internet connection and access procedure in accordance therewith. Examples of such browser programs include Netscape Communicator™ available from America Online of Sterling, Va. and Internet Explorer™ available from Microsoft Corporation of Redmond, Wash.

The downloaded Web page file 24 received from server 16 is typically formatted in HyperText Markup Language (HTML) that requires suitable processing for subsequent presentation on display terminal 26. For example, the browser program installed on Internet access device 12 may perform a conventional operation that involves processing the downloaded file by following the HTML document format instructions to properly present the information for viewing on display terminal 26.

The illustrated display terminal 26 is preferably provided in the form of an interactive, multi-media viewing apparatus capable of allowing a viewer to make desired selections of any of the displayed items. For example, display terminal 26 may include a conventional graphical user interface (GUI) having a tactile or touch-sensitive screen that permits a user to select a displayed element, which preferably can be represented by a graphical icon or menu item. Other user-activated selection mechanisms may be used, such as a mouse, cursor, or pen.

The downloaded Web page file 24 preferably includes information representing customer financial data, such as account information useful in rendering payment for a proposed refueling transaction. The type of financial data may include, but is not limited to, a credit card account number, a debit card account number, and a digital cash account number (e.g., a cyber-cash account at an Internet banking facility). It is clear that the use of such a URL-based access mechanism to gain access to a choice of financial transaction services enables the customer to use Internet-based electronic financial transfer services in the form of virtual or digital cash in lieu of a physical credit card.

The Web page 24 is preferably constructed to present the financial data in the form of selectable payment options each corresponding to a certain payment method. It is a preferred feature of the invention that Web page 24 is custom designed by the customer or under the guidance of the customer. For example, a service station operator may collect pertinent financial data from the customer and design a customized Web page using the collected data. The customer may then request updates or other modifications to the Web page by simply contacting the web site designer and submitting the appropriate corrections or revisions.

A customized HTML web page containing all of the relevant financial and refueling transaction information is also valuable is because it allows the display of linked information associated with credit cards and loyalty cards such as credit card balance, interest rates, promotional offers, airline points, discount structure, coupons, targeted advertising, and other data. It is a feature of Web page 24 that the service station operator (and other entities authorized by the customer) can insert information into the Web page 24 for subsequent viewing by the customer when the page is downloaded in response to a request from Internet access device 12.

Following presentation of the HTML Web page 24 on display terminal 26, the customer views the information and selects the appropriate form of payment, thereby generating a payment selection signal 28 representative thereof. This payment selection signal 28 is conventionally formatted and forwarded to a conventional point-of-sale (POS) facility 30 for subsequent processing. The POS processing typically includes verifying that the specified account number is authorized for use and determining that sufficient funds are available.

The manner of generating payment selection signal 28 is completely transparent to POS facility 30. In particular, once the desired credit card, promotional card, or loyalty card, for example, is selected at the gasoline dispenser user interface (i.e., display terminal 26), the corresponding selection data (e.g., account number) is submitted to the conventional dispenser system and used by POS facility 30 in a conventional manner as if a physical device had been used to issue the account information, such as a magnetic card reader scanning a credit card. The advantage which attends this feature is that the invention preferably requires no modifications to the existing dispenser equipment beyond appropriate installation of the indicated apparatus to render the dispenser position enabled for Internet access and usage.

Optionally, the Internet access device 12 and/or data retrieval mechanism 18 may be configured within a controller 32 that connects to Internet 14 and controls conventional fuel dispenser equipment 34. Controller 32 includes a conventional functionality that cooperates with POS facility 30 to manage the refueling operation in accordance with control signals issued thereto in any conventional manner, such as the amount and type of requested fuel.

Optionally, dispenser position 10 may include a security feature that authenticates the identity of the customer who is proposing to make a payment selection. This feature is introduced in order to prevent fraudulent use of the URL card. For example, retrieval of the requested Web page from server 16 is preferably preceded by the downloading of a user authorization Web page having a log-in field that requires the user to submit a personal identification number (PIN) or password. The user submits the PIN entry to server 16, which executes or otherwise requests execution of a verification check of the information. If the PIN is verified, server 16 downloads the requested financial Web page. Otherwise, the service station operator may be notified of this ostensible attempt to perform a fraudulent transaction.

It is preferable that all communications between the Internet-enabled fuel dispenser position and the host service (i.e., specified server or host resource) be conducted through a secure sockets layer common with TCP/IP communications.

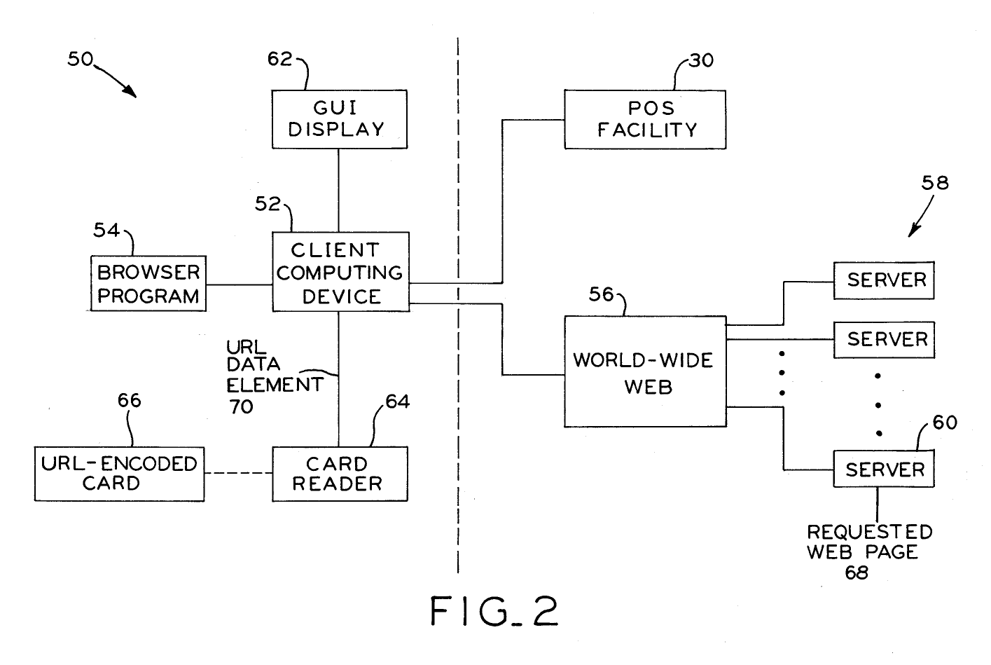

Referring now to FIG. 2, there is shown in block diagram format an Internet-enabled fuel dispenser position so located at a refueling environment such as a service station facility, according to another embodiment of the present invention. Although only a single dispenser position 50 is shown for purposes of clarity, it should be apparent that the refueling environment may include a plurality of such dispenser positions 50 each dedicated to serving a particular customer.

The Internet-enabled dispenser position 50 includes a computing device 52 configured as a client machine having a browser program 54 installed thereon to enable connection to the World-Wide Web 56 having a network 58 of interconnected servers 60. An appropriate network connection device (not shown) is used to connect client machine 52 to Web 56, such as a modem dial-up facility connecting to Web 56 via an internet service provider (e.g., AOL). The illustrated browser program 54 is representative of any suitable means for processing a Web page downloaded from Web 56, such as an HTML document.

The Internet-enabled dispenser position 50 also includes a graphical user interface (GUI) display 62 to enable viewing of files downloaded from Web 56. Preferably, GUI display 62 has a user-interactive capability enabling a viewer to select any one of the displayed items and generate a signal representative of the selection.

A card reader 64 connected to computing device 52 is provided in the form of an insert-type reading device capable of scanning and retrieving information encoded on a card element as it is properly maneuvered through the card slot in a conventional swiping motion. For this purpose, in order to facilitate a refueling transaction, a customer furnishes a card 66 previously encoded with at least one URL data element specifying the Internet address of a host resource (e.g., Web page 68 on server 60 of Web 56) that embodies customer financial data useful in making a payment selection. In one form, card 66 may include a magnetic strip having the URL data element embedded, impressed, or otherwise embodied therein. Accordingly, reader 64 will preferably be constructed in the form of a conventional magnetic card reader such as the type used in scanning credit cards.

In operation, a customer who is proposing to request a refueling transaction at dispenser position 50 supplies a URL-encoded card 66 and swipes the card through card reader 64 by first inserting and then withdrawing card 66 from the card processing slot provided by card reader 64. The information obtained by this reading operation is provided to client computing device 52 as URL data element 70. Client machine 52, in conjunction with browser program 54, formulates a request for access to the Internet location specified by the URL data element 70.

The request is received by Web 56 and appropriately routed to the specified server 60, which then downloads the requested Web page 68 to the client device, i.e., computing device 52. The downloaded Web page 68 is then suitably processed and presented for viewing on GUI display 62. The customer reviews the payment options displayed on GUI display and selects one of the display elements by touch-activating the corresponding graphical representation (e.g., icon or menu item).

The customer payment selection is forwarded to POS facility 30 in order to continue with the refueling transaction. For example, POS 30 will initiate an authorization procedure that involves submitting the referenced account number embodied in the payment selection to a credit authorization system. If authorization is approved, a fuel dispenser controller (not shown) will generate and issue the appropriate control commands to the dispenser equipment according to refueling transaction data (fuel type and amount) submitted by the customer in a conventional manner.

What has been shown and described herein is an improved method and apparatus that stores all credit card number information, promotional card information, loyalty program information, and other such relevant data at a remote host computer. A URL data element supplied by the customer in the form of a reprogrammable URL-encoded card is used to identify a unique HTML page stored on a remote server connected to the World Wide Web that includes such information. Preferably, the HTML page has been previously established by the customer using a subscription service that collects and records the credit card, promotional card, and loyalty program card information on the specified Web site page. The customer need only access this page and select the appropriate account to facilitate the financial aspect of the refueling transaction.

An Internet access device capable of recognizing and processing the URL data element is used to request that the customer HTML page be sent to the user interface screen at the gasoline dispenser so the appropriate “card” or combination of “cards” can be selection by the customer. This virtual selection method is analogous to selecting a form of payment by retrieving the corresponding physical card from a wallet. It is apparent that the functionality of a plurality of physical elements (i.e., cards) each representing a corresponding payment option can be replaced with a single physical device (i.e., a URL-encoded card) useful in retrieving an associated Web page from an accessed server.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A system for use in a fuel dispenser environment, comprising:
a connection facility enabling connection to a communications network;
data means for providing at least one resource identifier each specifying a host resource in said communications network; and
access means, operatively coupled to said connection facility, for accessing the host resource specified by a one of the at least one resource identifier and for receiving information retrieved therefrom.

2. The system as recited in claim 1, wherein the at least one resource identifier further includes at least one Uniform Resource Locator (URL) data element.

3. The system as recited in claim 2, wherein said communications network further includes the Internet, and the host resource associated with each resource identifier further includes at least one server.

4. The system as recited in claim 1, wherein information retrieved from an accessed host resource further includes a World Wide Web page document containing customer information relating to payment options.

5. The system as recited in claim 1, wherein said data means further comprises:
a device containing at least one Uniform Resource Locator (URL) data element; and
a retrieval mechanism to retrieve the at least one URL data element from said device.

6. The system as recited in claim 5, wherein said device further includes a card provided by a customer.

7. The system as recited in claim 5, wherein said device further comprises at least one of a magnetic card, a bar code element, a processor, and a wireless communications device.

8. The system as recited in claim 7, wherein said retrieval mechanism further comprises at least one of a magnetic card reader, a bar code reader, and a wireless communications receiver.

9. The system as recited in claim 1, wherein the information received by said access means further includes transaction information for use in facilitating a refueling operation.

10. The system as recited in claim 9, wherein the transaction information further includes at least one selectable payment option each representing a form of payment.

11. The system as recited in claim 10, further comprises:
a display to present said transaction information and to enable a selection operation relative to the at least one selectable payment option.

12. The system as recited in claim 10, further comprises:
means for processing the transaction information and enabling selection of at least one of the at least one selectable payment option.

13. The system as recited in claim 12, further comprises:
a point-of-sale facility to operatively conduct a refueling transaction operation using the payment option selection.

14. A system for use in a fuel dispenser environment having a plurality of dispenser positions, said system comprising:
connection means for enabling connection to a communications network;
each dispenser position respectively comprising:
a mechanism to provide at least one resource identifier each specifying a host resource in said communications network, and
an access device to access the host resource specified by a one of the at least one resource identifier and to receive information retrieved therefrom.

15. The system as recited in claim 14, wherein the at least one resource identifier further includes at least one Uniform Resource Locator (URL) data element.

16. The system as recited in claim 15, wherein said communications network further includes the Internet, and the host resource associated with each resource identifier further includes at least one server.

17. The system as recited in claim 14, wherein information retrieved from an accessed host resource further includes a World Wide Web page document containing customer information relating to payment options.

18. The system as recited in claim 14, wherein said mechanism further comprises:
a device containing at least one Uniform Resource Locator (URL) data element; and
a retrieval mechanism to retrieve the at least one URL data element from said device.

19. The system as recited in claim 14, wherein the information received by said access device further includes transaction information for use in facilitating a refueling operation.

20. The system as recited in claim 19, wherein the transaction information further includes at least one selectable payment option each representing a form of payment.

21. The system as recited in claim 20, further comprises:
a means to present the transaction information and to enable a selection operation relative to the at least one selectable payment option.

22. An apparatus for use in combination with a fuel dispenser environment and a communications network, said apparatus comprising:
a connection device to connect to said communications network;
a mechanism to provide at least one Uniform Resource Locator (URL) data element each specifying a host resource in said communications network; and
an access device to access the host resource specified by a one of the at least one resource identifier and to receive information retrieved therefrom.

23. The apparatus as recited in claim 22, wherein said mechanism further comprises:
a portable storage device containing the at least one URL data element; and
a retrieval device to retrieve the at least one URL data element from said portable storage device.

24. The apparatus as recited in claim 23, wherein said storage device further includes a card, and said retrieval device further includes a read module adapted to enable operative reading of said card.

25. The apparatus as recited in claim 22, wherein the information received by said access device further includes at least one selectable payment item each representing a form of payment for use in facilitating a refueling transaction.

26. (canceled)

27. (canceled)

28. (canceled)
